(19) United States
(12) Patent Application Publication
(10) Pub. No.: US 2009/0298491 A1
(43) Pub. Date: Dec. 3, 2009

(54) Contract Acceptance Systems and Methods

(75) Inventor: Nagesh Kadaba, Roswell, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 12/476,851

(22) Filed: Jun. 2, 2009

Related U.S. Application Data
(60) Provisional application No. 61/058,418, filed on Jun. 3, 2008.

(51) Int. Cl. G06F 3/033; G09G 5/00; H04M 3/00; G06F 3/041

(52) U.S. Cl. 455/419; 345/156; 345/179; 178/18.03

(57) ABSTRACT

According to various embodiments of the present invention, a contract acceptance system is provided for facilitating customer acceptance of a service contract (e.g., a wireless service contract). In particular, certain embodiments of the present invention allow a shipping carrier delivering a wireless communication device (e.g., a cellular phone) to a customer to facilitate customer acceptance of a new wireless service contract via a handheld computing device at the point of delivery.

### CROSS REFERENCE TO RELATED APPLICATIONS

This patent application claims priority from provisional patent Application No. 61/058,418, filed Jun. 3, 2008 and entitled “Contract Acceptance Systems and Methods,” which is herein incorporated by reference in its entirety.

### BACKGROUND OF THE INVENTION

Under current U.S. law, in order for a wireless service contract of over 2 years in length to be valid for its full term, the contract must be signed by the customer who is entering into the contract. If the contract is only verbally accepted, the contract will be regarded as being effective for only one year.

Because many wireless communication devices (e.g., cellular phones) and wireless plans are often purchased on-line or over the telephone (e.g., over a wireless communication device), improved techniques are needed for coordinating the signature of wireless service contracts by the customer.

### BRIEF SUMMARY OF VARIOUS EMBODIMENTS OF THE INVENTION

According to various embodiments of the present invention, contract acceptance systems and methods are provided for facilitating customer acceptance of a service contract (e.g., a wireless service contract). Various embodiments include a system for obtaining customer acceptance of a service contract for providing service to a delivered item, the system comprising: a handheld delivery information acquisition device, comprising: a processor; memory linked to the processor; a display; and a handwriting input device; wherein the handheld delivery information acquisition device is configured for: receiving an electronic signature via the handwriting input device; and after receiving the electronic signature, transmitting the electronic signature to a remote server to be stored as proof of acceptance by the signee of the service contract.

Various embodiments also include a system for obtaining customer acceptance of a wireless service contract for providing wireless service to a delivered wireless communication device, the system comprising: (A) a shipping carrier server configured to transmit information to and receive information from a handheld delivery information acquisition device; (B) a wireless carrier server configured to transmit information to and receive information from the shipping carrier server; (C) a handheld delivery information acquisition device, comprising: a processor, memory linked to the processor, a handwriting input device, and a display; wherein the handheld delivery information acquisition device is configured for: receiving, from the shipping carrier server, delivery information associated with a package containing the wireless communication device, wherein the delivery information is generated by a shipping carrier responsible for shipping the package; receiving, from the shipping carrier server, wireless service contract information including the terms of a wireless service contract associated with the wireless communication device, wherein: the wireless service contract information relates to an offer by a wireless carrier to provide wireless service for the wireless communication device according to the wireless service contract; displaying the wireless service contract via the display; after or while displaying the wireless service contract, receiving an electronic signature via the handwriting input device; and after receiving the electronic signature, transmitting the electronic signature to the shipping carrier server to be stored as proof of acceptance by the signee of the service contract.

Various embodiments also include a method of obtaining customer acceptance of a service contract for providing service to a particular item, the method comprising the steps of: (A) transporting a package to a customer on behalf of a seller of a particular item, the package containing the particular item; (B) obtaining positive identification of the customer; (C) obtaining an electronic signature from the customer using a handheld delivery information acquisition device, wherein: the handheld delivery information acquisition device comprises: a processor; memory linked to the processor; a display; and a handwriting input device; the handheld delivery information acquisition device is configured to: receive an electronic signature via the handwriting input device; and after receiving the electronic signature, transmit the electronic signature to a remote server; and the electronic signature serves at least as acceptance of the service contract associated with the particular item; (D) relinquishing the package to the customer; and (E) providing the seller with the electronic signature as proof of acceptance of the service contract by the customer.

Various embodiments also include a method of obtaining customer acceptance of a wireless service contract for providing service to a wireless communication device, the method comprising the steps of: (A) receiving a shipping notification from a wireless carrier, the notification indicating that the wireless carrier wishes to ship the wireless communication device to a customer of the wireless carrier; (B) receiving a package from the wireless carrier, the package including at least the wireless communication device; (C) transporting the package to the customer on behalf of the wireless carrier; (D) obtaining positive identification of the customer; (E) obtaining an electronic signature from the customer using a handheld delivery information acquisition device, wherein: (i) the handheld delivery information acquisition device comprises: a processor, memory linked to the processor, a display, and a handwriting input device; (ii) the handheld delivery information acquisition device is configured for: receiving an electronic signature via the handwriting input device, and after receiving the electronic signature, transmitting the electronic signature to a remote server; and (iii) the electronic signature serves at least as acceptance of the wireless service contract associated with the wireless communication device; (F) relinquishing the package to the customer; and (G) transmitting the electronic signature to a remote server using the handheld delivery information acquisition device to store as proof of acceptance of the wireless service contract by the customer.

Various embodiments also include a computer readable medium storing computer executable instructions for: receiving delivery information relating to the delivery of a package containing a particular item; receiving service contract information including the terms of a service contract associated with the particular item; displaying a service contract via the display of a handheld delivery information acquisition device; receiving an electronic signature via the handwriting input device of a handheld delivery information acquisition device; and transmitting the electronic signature to a remote server to store as proof of the acceptance by the signee of a service contract.

### BRIEF DESCRIPTION OF DRAWINGS

FIG. 1 is a schematic diagram showing a communication network between a wireless carrier server, a shipping carrier server, and a handheld computer device according to various embodiments of the invention.

FIG. 2 is a schematic diagram of a shipping carrier server according to a particular embodiment.

FIG. 3 is a flow chart depicting a basic overview of various steps executed in transporting a wireless communication device to a customer.

FIG. 4 is a first flow chart depicting various steps involved in delivering a wireless communication device to a customer, according to various embodiments.

FIG. 5 is a second flow chart depicting various steps involved in delivering a wireless communication device to a customer, according to another embodiment.

FIG. 6 is a third flow chart depicting various steps involved in delivering a wireless communication device to a customer, according to yet another alternative embodiment.

### DETAILED DESCRIPTION OF VARIOUS EMBODIMENTS OF THE INVENTION

Various embodiments now will be described with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### Overview

According to various embodiments of the present invention, a contract acceptance system is provided for facilitating customer acceptance of a service contract (e.g., a wireless service contract). In particular, certain embodiments of the present invention allow a shipping carrier delivering a wireless communication device (e.g., a cellular phone) to a customer to facilitate customer acceptance of a new wireless service contract via a handheld computing device at the point of delivery.

In the wireless communications industry, a customer requesting wireless service for a wireless communication device typically agrees to a wireless service contract that is to last for a certain period of time. If the contract is for one year or less, under current U.S. law the customer does not have to physically sign the contract in order for the contract to be binding. However, if the contract is for more than one year (e.g., a two-year contract), the customer must sign the contract in order for the contract to be legally binding for longer than one year. In addition to obtaining the customer's signature to accept a wireless service contract, it is also common for a wireless carrier to provide a new wireless communication device to a customer entering into the new wireless service contract. Frequently, the wireless carrier employs the services of a shipping carrier to ship the wireless communication device to the customer.

Accordingly, various embodiments of the contract acceptance system allow the shipping carrier to perform a series of tasks at the point of delivery to facilitate the customer's acceptance of both the package containing the wireless communication device and the wireless service contract associated with the device. To perform these tasks, according to various embodiments, the contract acceptance system includes a handheld computing device that allows an agent of the shipping carrier to receive and transmit information about shipments, obtain electronic signatures from customers, and perform a variety of other delivery tasks. In certain embodiments, this handheld computing device is a Delivery Information Acquisition Device (“DIAD”).

For example, according to various embodiments, a wireless carrier employing a shipping carrier to deliver a cellular telephone may request that an agent of the shipping carrier (e.g., a driver) obtain positive identification of the customer before relinquishing the package containing the cellular phone or presenting a wireless service contract to the customer for acceptance. Accordingly, in certain embodiments, the contract acceptance system's handheld computing device is configured to require the driver to confirm the customer's identity (e.g., by drivers license, credit card number, or signature) before completing the delivery.

In addition, according to various embodiments, the contract acceptance system allows the shipping carrier to, at the point of delivery, obtain customer acceptance of a wireless service contract associated with the wireless communication device being delivered by the shipping carrier. For example, in certain embodiments, the contract acceptance system's handheld computing device is configured to display the wireless service contract for the wireless communication device being delivered to the customer. After the customer reviews the contract as displayed on the handheld computing device, the customer provides an electronic signature via a handwriting input device on the handheld computing device to accept the contract. In other embodiments, the wireless carrier mails, emails, faxes, or otherwise provides a wireless service contract to the customer prior to delivery of the wireless communication device. In such embodiments, the driver then obtains an electronic signature from the customer using the handheld computing device to confirm the customer's acceptance of the previously reviewed contract.

In other various embodiments, the wireless carrier includes a paper copy of a wireless service contract with the shipped wireless communication device, and the driver provides the contract to the customer upon delivery. In one such embodiment, the paper contract may be enclosed in a pouch on the outside of the package containing the wireless communication device or otherwise secured to the package. Upon delivery of the package to the customer, the driver removes the paper contract from the package and presents the customer with the contract for review. After the customer reviews the contract, the customer returns the contract to the driver and provides an electronic signature via the handheld computing device serving as proof of acceptance of the wireless service contract.

According to various embodiments, an electronic signature received by the handheld computing device may serve as proof of the customer's acceptance of the package being delivered, the customer's acceptance of the wireless service contract, or both. In certain embodiments, the handheld computing device is configured such that the customer may sign separately to indicate: (1) acceptance of the package and (2) acceptance of the contract.

According to various embodiments, once the driver obtains the electronic signature of the customer, the handheld computing device is further configured to transmit the signature and other related information to the wireless carrier via one or more communication networks and servers comprising the contract acceptance system.

### Exemplary Contact Acceptance System

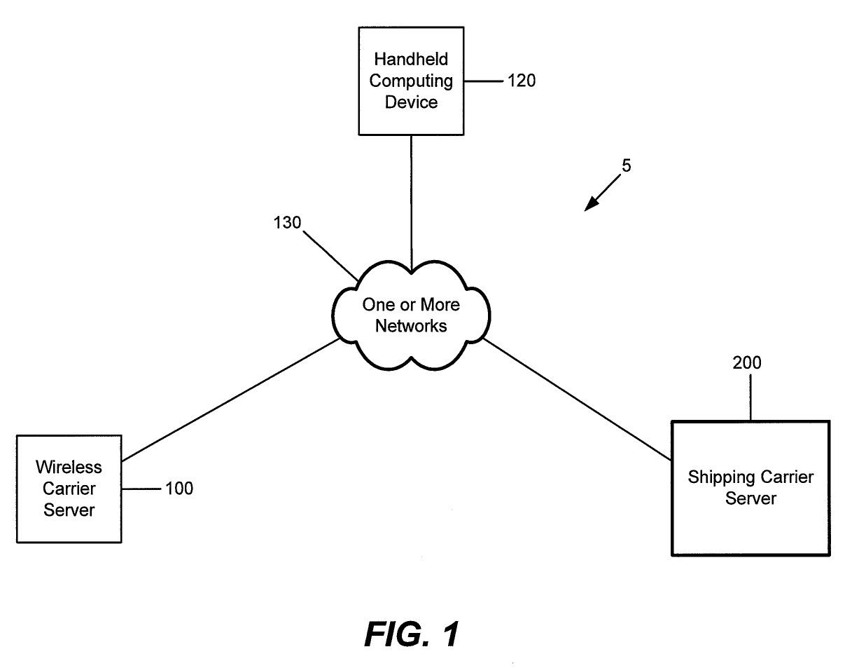

A contract acceptance system 5 according to one embodiment is shown in FIG. 1. In the illustrated embodiment, the contract acceptance system 5 includes a wireless carrier server 100 associated with a wireless carrier, a shipping carrier server 200 associated with a shipping carrier, and a handheld computing device 120 (e.g., a DIAD). The handheld computing device 120 may be, for example, an electronic communication device through which a shipping carrier communicates with a driver to provide the driver with various types of information, including information related to the delivery of packages. These components communicate over one or more networks 130 (e.g., wired or wireless networks via the Internet or other suitable network). For example, the wireless carrier server 100 is configured to communicate with the shipping carrier server 200 over one of the one or more networks 130, while the shipping carrier server 200 communicates with the handheld computing device 120 over the same network or a different one of the one or more networks 130.

According to the embodiment shown in FIG. 1, the contract acceptance system 5 operates by using the wireless carrier server 100 to initiate the contract acceptance process and the shipping carrier server 200 and handheld computing device 120 to execute the contract acceptance process. The wireless carrier server 100 is configured to provide the shipping carrier server 200 with a notification that the wireless carrier wishes to ship a wireless communication device to a customer who has entered into (or has indicated an intention to enter into) a wireless service contract (e.g., a new wireless service contract over 1 year in duration). The shipping carrier server 200 is configured to provide the handheld computing device 120 with delivery information associated with a package containing the wireless communication device so that a shipping carrier driver may deliver the package to the customer. The transfer of information between the wireless carrier server 100, the shipping server 200, and the handheld computing device 120 may be accomplished using conventional communication methods.

As is discussed in more detail below, the handheld computing device 120 is configured to generate an electronic signature from customer input received via a handwriting input device (e.g., using a pen to sign a pen-sensing surface of the handheld computing device 120). In one embodiment, the handwriting input device of the handheld computing device 120 comprises a portion of the display of the handheld computing device 120 configured to sense the movement of a pen. In another embodiment, the handwriting input device of the handheld computing device 120 comprises a pen-sensing surface (e.g., a surface of the handheld computing device 120 or a remote pad) configured to sense the movement of a pen. In yet another embodiment, the handwriting input device of the handheld computing device 120 comprises a pen configured to sense the pen's movement across a particular surface (e.g., a surface of the handheld computing device 120).

The handheld computing device 120 is further configured to transmit to the shipping carrier server 200 the electronic customer signature received via the handwriting input device, as well as other information related to the delivery of the package to the customer. The shipping carrier server 200 is further configured to transmit the information received from the handheld computing device 120 back to the wireless carrier server 100. The wireless carrier server 100 is configured to store the received information as documentation of the signature of the wireless service contract by the customer.

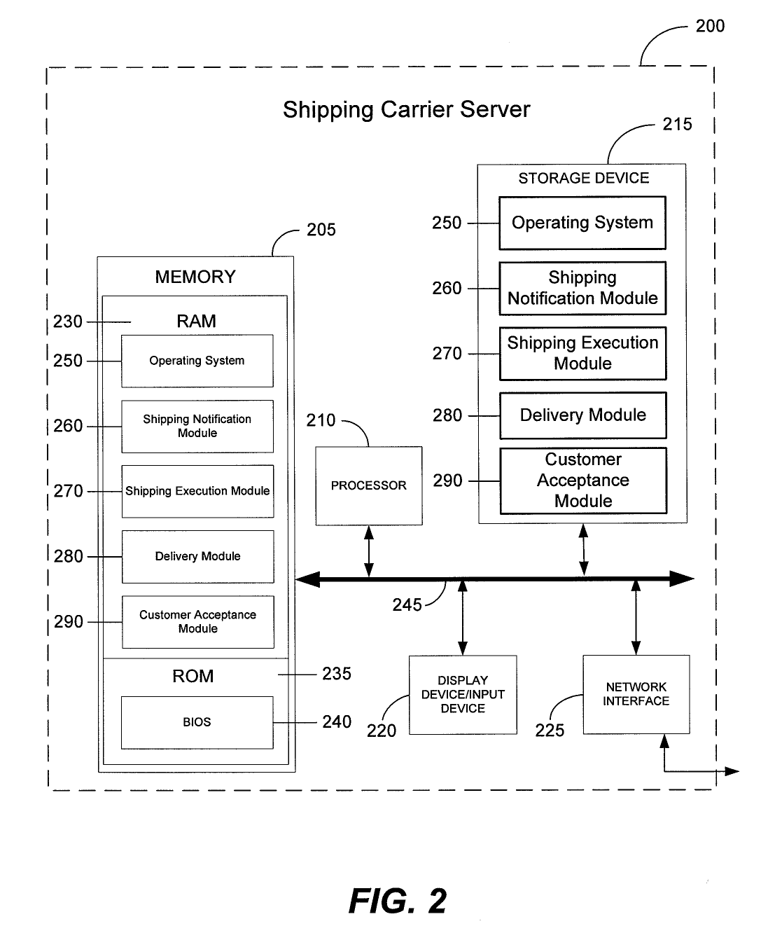

FIG. 2 is a schematic diagram of the shipping carrier server 200 according to one embodiment. The shipping carrier server 200 includes a processor 210 that communicates with other elements within the shipping carrier server 200 via a system interface or bus 245. Also included in the shipping carrier server 200 is a display device/input device 220 for receiving and displaying data. This display device/input device 220 may be, for example, a keyboard or pointing device that is used in combination with a monitor. The shipping carrier server 200 further includes memory 205, which preferably includes both read only memory (ROM) 235 and random access memory (RAM) 230. The server's ROM 235 is used to store a basic input/output system 240 (BIOS), containing the basic routines that help to transfer information across the one or more networks 130 or between elements within the shipping carrier server 200.

In addition, the shipping carrier server 200 includes at least one storage device 215, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 215 is connected to the system bus 245 by an appropriate interface. The storage devices 215 and their associated computer-readable media provide nonvolatile storage for a personal computer. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 230. Such program modules include an operating system 250, a Shipping Notification Module 260, a Shipping Execution Module 270, a Delivery Module 280, and a Customer Acceptance Module 290. The Shipping Notification Module 260, Shipping Execution Module 270, Delivery Module 280, and Customer Acceptance Module 290 control certain aspects of the operation of the shipping carrier server 200, with the assistance of the processor 210 and operating system 250.

According to various embodiments, the Shipping Notification Module 260 is configured to receive and process an incoming notification from a wireless carrier in which the wireless carrier indicates that it wishes to ship a wireless communication device to a customer (e.g., a customer entering into a new wireless service contract). The Shipping Execution Module 270 is configured to receive information from the Shipping Notification Module 260, place a shipping order, and manage the shipping process from order through delivery. The Delivery Module 280 is configured to transmit information received from the Shipping Execution Module 270 to the handheld computing device 120 to provide a shipping carrier driver with instructions on how to make deliveries, including notification to the driver that the driver is acting on behalf of a wireless carrier to obtain customer acceptance of a new wireless service contract. The Customer Acceptance Module 290 is configured to receive an electronic customer signature and other information related to the delivery of a phone to a customer from the handheld computing device 120 and transmit that information to the wireless carrier server 100.

Also located within the shipping carrier server 200 is a network interface 225 for interfacing and communicating with other elements of a computer network (e.g., network 130). It will be appreciated by one of ordinary skill in the art that one or more of the shipping carrier server 200 components may be located geographically remotely from other shipping carrier server 200 components. Furthermore, one or more of the components may be combined, and additional components performing functions described herein may be included in the shipping carrier server 200.

### Order Placement and Shipping Carrier Notification

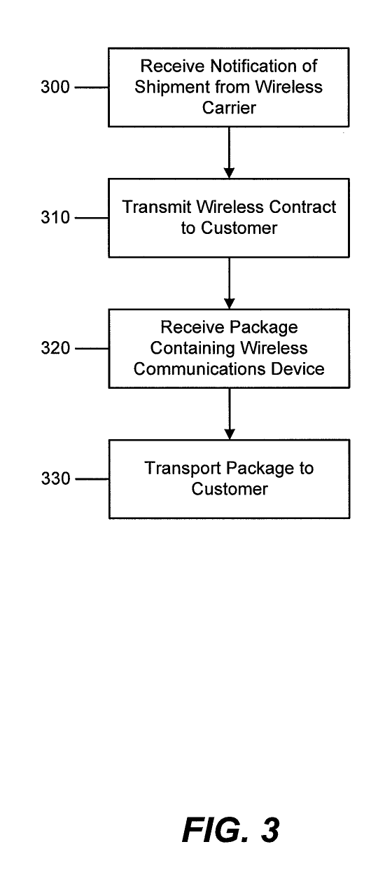

FIG. 3 illustrates exemplary steps taken by a shipping carrier to transport a wireless communication device to a customer according to various embodiments. Beginning at Step 300, the shipping carrier receives notification from a wireless carrier of a request to ship a wireless communication device to a customer seeking to enter into a contract for wireless service. In addition to the notification to ship the wireless communication device, the wireless carrier also requests the shipping carrier to, upon delivery of a package including the wireless communication device, obtain the signature of the customer as proof of acceptance of a new wireless service contract. Referring back to FIG. 1, in certain embodiments, Step 300 may be accomplished by transmitting delivery information from the wireless carrier server 100 to the shipping server 200 over one or more networks 130. In one embodiment, the Shipping Notification Module 260 controls the shipping server 200 as it receives and processes the incoming notification.

Next, at Step 310, the shipping carrier provides the customer with a new wireless service contract (e.g., the contract between the customer and the wireless carrier). In certain embodiments, the shipping carrier receives a paper copy (e.g., via mail) or electronic copy (e.g., via the servers 100, 200 and networks 130) of the contract form the wireless carrier. According to various embodiments, the shipping carrier then provides the contract to the customer prior to delivery of the wireless communication device by, for example: (1) e-mailing the contract to the customer; (2) providing the customer with a link to a web site on which the customer may access and review the contract; (3) mailing the customer a paper copy of the contract; (4) faxing the customer a copy of the contract; or (5) any other suitable means of communication. However, in certain other embodiments, Step 310 may occur at the point of delivery of the wireless communication device as the shipping carrier provides the contract to the customer for review via a display screen of a handheld computing device (e.g., the handheld computing device 120) or in paper form. In other alternative embodiments, Step 310 may be accomplished by the wireless carrier providing the customer with the wireless service contract without the assistance of the shipping carrier.

As explained in greater detail below, in certain embodiments where the contract is provided for the customer's review prior to delivery, the shipping carrier may also prepare the wireless service contract for later presentation to the customer via a handheld computing device (e.g., the handheld computing device 120). For example, in one embodiment, the shipping carrier downloads an electronic copy of the contract to the handheld computing device that will be viewable by the customer at the point of delivery and used to obtain the customer's signature verifying delivery of the wireless communication device and/or acceptance of the wireless service contract. As is also discussed in greater detail below, providing an advance electronic copy of the contract to the customer may allow the customer to review the contract before the wireless communication device is delivered to the customer. According to various embodiments, providing an advance copy of the contract to the customer may expedite the process of obtaining acceptance of the wireless service contract from the customer upon delivery of the wireless communication device to the customer.

Next (or at the same time as the notification step 300 described above), at Step 320, the shipping carrier receives a package containing the wireless communication device. In certain embodiments, the wireless carrier delivers the package containing the wireless communication device to the shipping carrier or an agent of the shipping carrier for delivery to the customer. In other embodiments, the shipping carrier picks up a package containing the wireless communication device from the wireless carrier or an agent of the wireless carrier.

Next, at Step 330, the shipping carrier transports the package to the customer. In one embodiment, this process is aided by the shipping server 200 where the Shipping Notification Module 260 is configured to send the shipping information received from the wireless carrier to the Shipping Execution Module 270. The Shipping Execution Module 270 then places the shipping order for transporting the package and manages, processes, and tracks the order as the package is transported through the shipping network to the customer. In addition, the Delivery Module 280 sends at least a portion of the shipping information to the handheld computing device 120.

As noted above, in certain embodiments, the package includes a copy of the new wireless service contract associated with the wireless communication device. In one embodiment, the contract is stored in an enclosure that is affixed to the package. However, in other embodiments, the package does not include a copy of the new wireless service contract. In such embodiments, as discussed briefly above, the wireless carrier provides the contract to the customer prior to the delivery of the wireless communication device and/or at the point of the delivery via the handheld computing device (e.g., the handheld computing device 120).

### Delivery to the Customer

When the shipping carrier driver is in possession of the package containing the wireless communication device and is in route to deliver the package to the customer, the package containing the wireless communication device may or may not be in a different configuration than any other types of packages that the driver is in the process of delivering. For example, certain packages may include a contract pouch on the exterior surface of the package, while others do not.

Accordingly, in various embodiments, the contract acceptance system (e.g., system 5) is configured to notify the driver of packages being delivered to a customer for whom the driver is to obtain customer acceptance of a new wireless contract on behalf of a wireless carrier. In certain embodiments, the notification to the driver includes instructions to obtain positive identification of the customer, as well as to obtain an electronic signature from the customer upon delivery of the package to the customer.

According to certain embodiments, such as the embodiment illustrated in FIG. 1, the shipping carrier server 200 is configured to provide such notification to the driver via the handheld computing device 120. In such embodiments, the Delivery Module 280 of the shipping carrier server 200 is configured to notify the driver of the impending delivery by automatically sending information to the handheld computing device 120 informing the driver of the various tasks the driver is requested to perform (e.g., obtain positive identity of the driver, obtain the customer's signature).

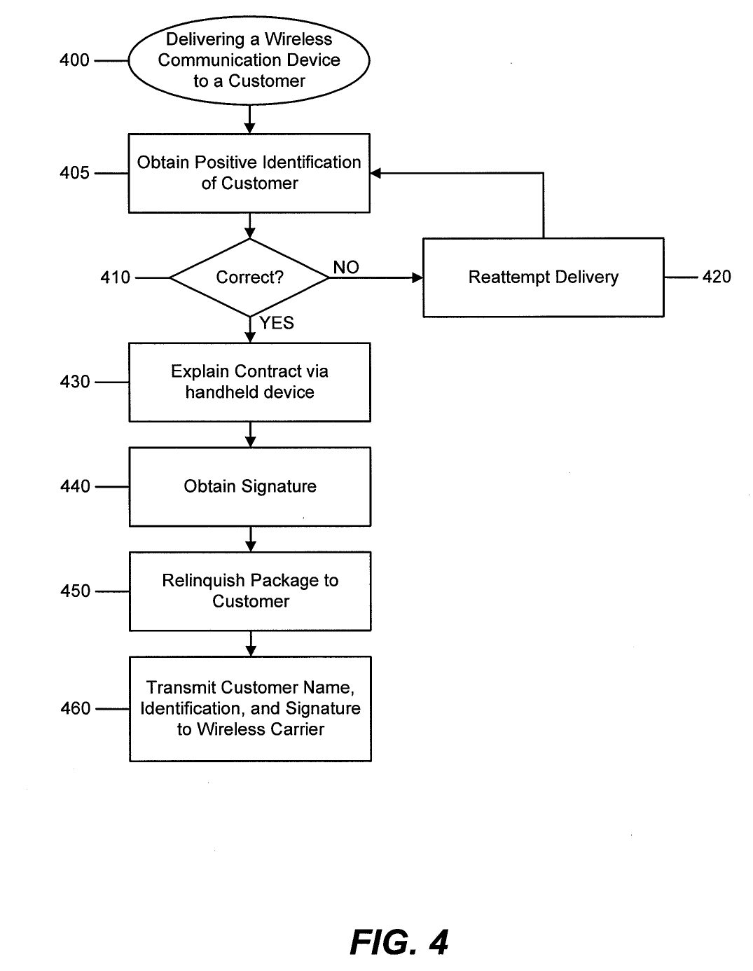

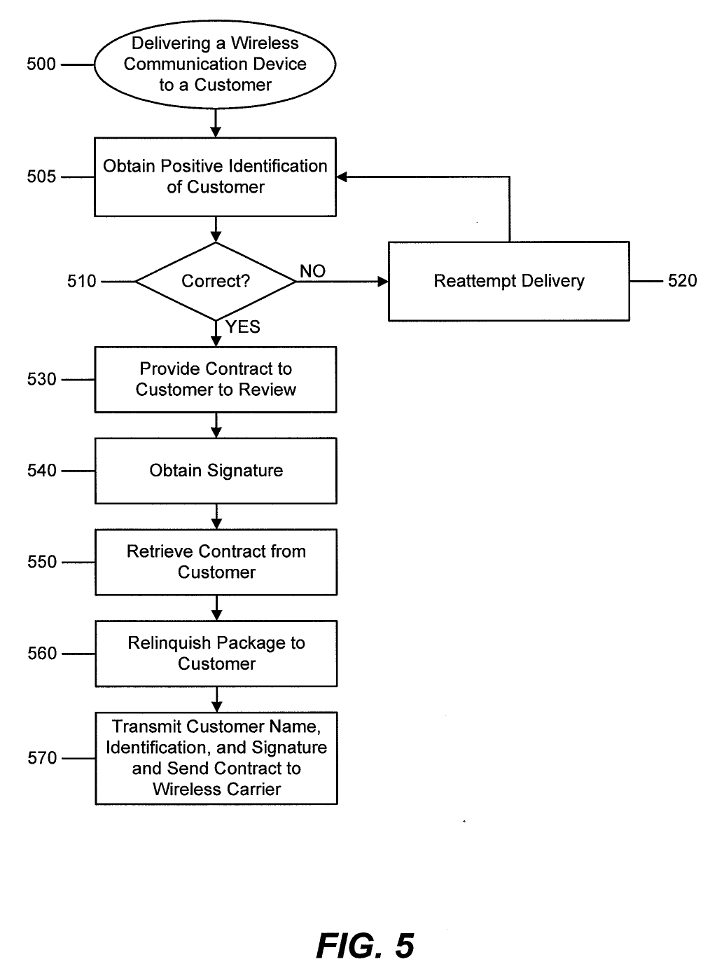

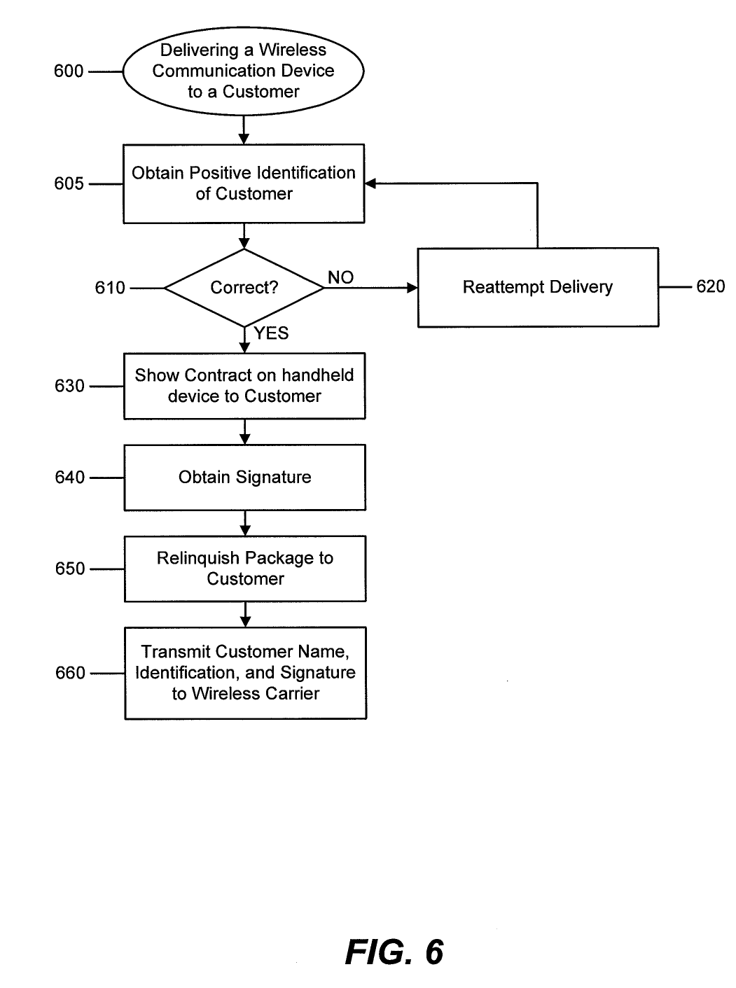

In various embodiments, the wireless carrier specifies particular business rules related to the delivery process. For example, in certain embodiments, the wireless carrier may specify that the wireless service contract be provided to the customer (e.g., via mail, email, website, etc.) prior to delivery of the wireless communication device (e.g., as described below in relation to FIG. 4), and in other embodiments, the wireless carrier may specify that the wireless service contract not be provided to the customer prior to delivery of the wireless communication device (e.g., as described below in relation to FIGS. 5 and 6). In yet another embodiment (not shown), the wireless carrier may specify that the wireless service contract be provided to the customer prior to delivery of the wireless communication device and again at the delivery of the wireless communication device. As another example, according to various embodiments, the wireless carrier may require that the customer's signature for the package also serve as the signature for the acceptance of the new wireless service contract, and in other embodiments, the wireless carrier may require that separate signatures be obtained.

FIGS. 4-6 illustrate exemplary embodiments of methods of delivering a wireless communication device to a customer. In particular, these figures illustrate exemplary steps taken by a shipping carrier driver (i.e., an agent of the shipping carrier) to deliver a package containing a wireless communication device to a customer and obtain the signature of that customer as proof of acceptance of a wireless service contract associated with the wireless communication device.

FIG. 4 illustrates a method 400 of delivering the wireless communication device to the customer according to one embodiment in which the wireless carrier provides the wireless contract to the customer prior to delivery of the wireless communication device. The method 400 begins at Step 405 by the driver obtaining positive identification of the individual attempting to accept the package at the indicated delivery address. To obtain positive identification, the driver may obtain, for example, the driver's license, identification card, passport, a credit card, or other suitable identification source of the individual attempting to accept the package, according to various embodiments.

Next, at Step 410, the driver determines whether the individual attempting to accept the package is the intended customer. In certain embodiments, the driver compares the name of the individual listed on the provided identification source with the name on the package and, if available, compares the picture of the individual on the information source with the appearance of the individual accepting the package. If this information from the information source matches that provided in the delivery information, the driver concludes that the individual attempting to accept the package is the intended customer. If not, the driver concludes that the individual attempting to accept the package is not the customer and proceeds to Step 420 in which the driver attempts redelivery to the customer at a later time.

In certain embodiments, the driver accomplishes Step 410 using a handheld computing device specifically configured to require the driver to submit a customer identifying number (e.g., the customer's drivers license number, passport number, or credit card number) to confirm to the customer's identity. This submission may be accomplished, for example, by manually entering the customer identifying number or by swiping the customer's license, passport, or credit card through an electronic reader. In further embodiments, the handheld computing device is configured such that the customer is prevented from accepting the package or service contract (e.g., by signature) until a matching customer identifying number is obtained.

If the proper customer has been identified, at Step 430 the driver explains to the customer the customer's new wireless service contract. In one embodiment, the driver uses the display screen of the handheld computing device (e.g., handheld computing device 120) to display the contract to the customer and communicate to the customer that the customer's signature for the package containing the wireless communication device will also serve as the signature for acceptance of the new wireless service contract. In other embodiments, the handheld computing device is configured to display the contract to the customer, and the driver indicates to the customer that the customer's signature for the package will also serve as acceptance of the new wireless service contract. In other embodiments, the handheld computing device or driver indicates that separate signatures are required for acceptance of the package and acceptance of the wireless service contract.

Next, at Step 440, the driver obtains the customer's signature on the driver's handheld computing device (e.g., by having the customer sign the driver's handheld computing device using suitable electronic signature capture techniques) indicating acceptance of the wireless service contract and the package (e.g., one signature indicating acceptance of both the contract and the package, or a separate signature indicating acceptance for each as noted above). In various embodiments, the handheld computing device, prior to the customer providing an electronic signature, displays a message informing the customer of the effect of the customer's signature (e.g., that the customer's signature serves as both the proof of acceptance of the package and the wireless service contract or that separate signatures are required for acceptance of each). In various other embodiments, the effect of the customer's signature may be communicated to the customer by the driver. In certain embodiments, as described above, Step 440 is accomplished by the handheld computing device's handwriting input device.

Next, at Step 450, the driver relinquishes the package to the customer upon receipt of the customer's signature. Next, at Step 460, the handheld computing device transmits customer-related information (e.g., the customer's name, the customer identification provided—for example, the customer's driver's license number or credit card number, and/or the customer's signature) to the shipping carrier server 200. In various embodiments, Step 460 is accomplished by the handheld computing device 120 transmitting the customer-related information to the shipping carrier server 200 over the one or more networks 130 (e.g., a wireless network). In addition, in various embodiments, the shipping carrier server 200 subsequently provides the customer-related information to the wireless carrier by, for example, transmitting the customer-related information to the wireless carrier server 100. This may be accomplished by the Customer Acceptance Module 290 of the shipping carrier server 200, which is configured to receive the electronic customer signature and other delivery information from the handheld computing device 120 and transmit that information to the wireless carrier server 100.

FIG. 5 illustrates a method 500 of delivering the wireless communication device to the customer according to an alternative embodiment in which the wireless carrier does not provide the wireless contract to the customer prior to delivery of the wireless communication device. In the illustrated embodiment, the wireless carrier includes the new wireless service contract with the package containing the wireless communication device. For example, the contract may be stored in an enclosure that is affixed to or included in the package.

The method 500 begins at Step 505 by the driver obtaining a positive identification of the customer, as described above in relation to Step 405 shown in FIG. 4. Then, at Step 510, the driver verifies the identity of the customer, and if the identity cannot be verified, attempts redelivery of the package at Step 520, such as described above in relation to Steps 410 and 420 shown in FIG. 4.

If the driver verifies the identity of the customer, the driver provides the customer with the new wireless service contract that is included with the package and allows the customer to review the contract, as shown at Step 530. Next, at Step 540, the driver obtains the customer's signature using the handheld computing device in the manner described above in relation to FIG. 4.

In certain embodiments, the contract includes a statement informing the customer of the effect of the customer's signature. For example, in one embodiment, the contract indicates that the customer's signature will serve as both the proof of acceptance of the package as well as acceptance of the wireless service contract, and in another embodiment, the contract indicates that separate signatures are required for each. In other embodiments, the handheld computing device, prior to the customer providing an electronic signature, displays a message informing the customer of the effect of the customer's signature. In various other embodiments, the effect of the customer's signature may be communicated to the customer by the driver.

Next, at Step 550, the driver retrieves the contract from the customer. Then, at Step 560, the driver relinquishes the package to the customer. Finally, at Step 570, the handheld computing device transmits customer-related information (e.g., the customer's name, the customer identification provided—for example, the customer's driver's license number or credit card number, and/or the customer's signature) to the shipping carrier server (e.g., shipping carrier server 200). In various embodiments, Step 570 is accomplished by the handheld computing device 120 transmitting the customer-related information to the shipping carrier server 200 over the one or more networks 130. In addition, in various embodiments, the shipping carrier server 200 subsequently provides the customer-related information to the wireless carrier by, for example, transmitting the customer-related information to the wireless carrier server 100. This may be accomplished by the Customer Acceptance Module 290 of the shipping carrier server 200, which is configured to receive the electronic customer signature and other delivery information and transmit that information to the wireless carrier server 100. In particular embodiments, the shipping carrier transmits the paper contract to the wireless carrier via the shipping carrier's own delivery services or by standard mail.

FIG. 6 illustrates a method 600 of delivering the wireless communication device to the customer according to yet another alternative embodiment in which the wireless carrier does not provide the wireless contract to the customer prior to delivery of the wireless communication device. In the illustrated embodiment, the driver presents the new wireless service contract to the customer on a display screen of a handheld computing device (e.g., the driver's handheld computing device 120) at the time of delivery of the wireless communication device.

The method 600 begins at Step 605 by the driver obtaining a positive identification of the customer, as described above in relation to Step 405 shown in FIG. 4. Then, at Step 610, the driver verifies the identity of the customer, and if the identity cannot be verified, attempts redelivery of the package at Step 620, such as described above in relation to Steps 410 and 420 shown in FIG. 4.

If the driver verifies the identity of the customer, the handheld computing device displays the new wireless service contract, and the driver provides the handheld computing device to the customer to review the contract as shown at Step 630. Next, at Step 640, the driver obtains the customer's signature using the handheld computing device as described above in relation to FIG. 4. In certain embodiments, the contract displayed on the handheld computing device includes a statement informing the customer of the effect of the customer's signature (e.g., one signature will serve as both the proof of acceptance of the package and the wireless service contract or separate signatures are required for each). In other embodiments, the effect of the customer's signature may be communicated to the customer by the driver.

Next, at Step 650, the driver relinquishes the package to the customer. Finally, at Step 660, the handheld computing device transmits customer-related information (e.g., the customer's name, the customer identification provided—for example, the customer's driver's license number or credit card number, and/or the customer's signature) to the shipping carrier server (e.g., shipping carrier server 200). In various embodiments, Step 460 is accomplished by the handheld computing device 120 transmitting the customer-related information to the shipping carrier server 200 over the one or more networks 130. In addition, in various embodiments, the shipping carrier server 200 subsequently provides the customer-related information to the wireless carrier by, for example, transmitting the customer-related information to the wireless carrier server 100. This may be accomplished by the Customer Acceptance Module 290 of the shipping carrier server 200, which is configured to receive the electronic customer signature and other delivery information and transmit that information to the wireless carrier server 100.

As will be appreciated by one skilled in the art, various embodiments of the present invention may be embodied as a method, a data processing system, or a computer program product. Accordingly, various embodiments of the present invention may take the form of an entirely hardware embodiment, an entirely software embodiment, or an embodiment combining software and hardware aspects. Furthermore, various embodiments of the present invention may take the form of a computer program product on a computer-readable storage medium having computer-readable program instructions (e.g., computer software) embodied in the storage medium. More particularly, various embodiments of the present invention may take the form of web-implemented computer software. Any suitable computer-readable storage medium may be utilized including hard disks, CD-ROMs, optical storage devices, or magnetic storage devices.

The various embodiments of the present invention described above with reference to block diagrams and flowchart illustrations of methods, apparatuses (e.g., systems) and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks. Accordingly, blocks of the block diagrams and flowchart illustrations support combinations for performing the specified functions, combinations of steps for performing the specified functions, and program instructions for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

### Conclusion

It should be understood that while the above embodiments are described largely in the context of the delivery of wireless communication devices and wireless service contracts, the same techniques may be used in regard to any other suitable type of product and any other suitable type of service contract (or other contract). Accordingly, many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended inventive concepts. Although specific terms are employed herein, they are used in a generic and descriptive sense only and not for purposes of limitation.

1. A system for obtaining customer acceptance of a service contract for providing service to a delivered item, said system comprising:
a handheld delivery information acquisition device comprising:
a processor;
memory linked to said processor;
a display; and
a handwriting input device;
wherein said handheld delivery information acquisition device is configured for:
receiving an electronic signature via said handwriting input device; and
after receiving said electronic signature, transmitting said electronic signature to a remote server to be stored as proof of acceptance by the signee of said service contract.

2. The system of claim 1, wherein said handheld delivery information acquisition device is further configured for:
before receiving said electronic signature, receiving service contract information associated with said service contract; and
before receiving said electronic signature, displaying said service contract via said display.

3. The system of claim 1, wherein said handheld delivery information acquisition device is further configured for, before receiving said electronic signature, displaying information indicating that an electronic signature provided via said handwriting input device will serve as proof of acceptance of said package by the signee.

4. The system of claim 1, wherein said handheld delivery information acquisition device is further configured for, before receiving said electronic signature, displaying information indicating that an electronic signature provided via said handwriting input device will serve as proof of acceptance by the signee of said service contract.

5. The system of claim 1, wherein said handheld delivery information acquisition device is further configured for, before receiving said electronic signature, displaying information indicating that an electronic signature provided via said handwriting input device will serve as proof of acceptance by the signee of said package and proof of acceptance by the signee of said service contract.

6. The system of claim 1, wherein:
said electronic signature is a first electronic signature; and
said handheld delivery information acquisition device is further configured for:
receiving a second electronic signature via said handwriting input device;
before or while receiving said first electronic signature, displaying information indicating that said first electronic signature provided via said handwriting input device will serve as proof of acceptance by the signee of said service contract; and
before or while receiving said second electronic signature, displaying information indicating that said second electronic signature provided via said handwriting input device will serve as proof of acceptance by the signee of said package.

7. The system of claim 2, wherein said service contract information is received from a shipping carrier server.

8. The system of claim 1, wherein:
said item is a wireless communication device; and
said service contract is a wireless service contract.

9. The system of claim 1, wherein said handheld delivery information acquisition device is further configured for, before receiving said electronic signature, displaying information instructing a shipping carrier agent to obtain positive identification of an authorized recipient of said package before relinquishing said package.

10. The system of claim 1, wherein:
said handwriting input device comprises a pen configured for writing-like movement on a surface of said display; and
said display is configured for receiving input from said pen such that the movement of said pen on said display is tracked and stored as an electronic signature.

11. The system of claim 1, wherein said handwriting input device comprises:
a pen configured for writing like movement on a pen-sensing surface; and
a pen-sensing surface configured for sensing the movement of said pen such that said sensed movement of said pen is tracked and stored as an electronic signature.

12. The system of claim 1, wherein:
said handwriting input device comprises a pen configured for tracking the pen's movement over a particular surface such that said tracked movement may be stored as an electronic signature.

13. The system of claim 1, further comprising a shipping carrier server configured for transmitting information to and receiving information from said handheld delivery information acquisition device; and
wherein said remote server is said shipping carrier server.

14. The system of claim 13, wherein said handheld delivery information acquisition device is further configured for, before receiving said electronic signature, receiving from said shipping carrier server delivery information associated with a package containing said item.

15. The system of claim 2, further comprising a shipping carrier server configured for transmitting information to and receive information from said handheld delivery information acquisition device;
wherein said remote server is said shipping carrier server; and
wherein said handheld delivery information acquisition device is further configured for receiving said service contract information from said shipping carrier server.

16. A system for obtaining customer acceptance of a wireless service contract for providing wireless service to a delivered wireless communication device, said system comprising:
(A) a shipping carrier server configured to transmit information to and receive information from a handheld delivery information acquisition device;
(B) a wireless carrier server configured to transmit information to and receive information from said shipping carrier server;
(C) a handheld delivery information acquisition device, comprising:
a processor,
memory linked to said processor,
a handwriting input device, and
a display;
wherein said handheld delivery information acquisition device is configured for:
receiving, from said shipping carrier server, delivery information associated with a package containing said wireless communication device, wherein said delivery information is generated by a shipping carrier responsible for shipping said package; and
receiving, from said shipping carrier server, wireless service contract information including the terms of a wireless service contract associated with said wireless communication device, wherein:
said wireless service contract information relates to an offer by a
wireless carrier to provide wireless service for said wireless communication device according to said wireless service contract;
displaying said wireless service contract via said display;
after or while displaying said wireless service contract, receiving an electronic signature via said handwriting input device; and
after receiving said electronic signature, transmitting said electronic signature to said shipping carrier server to be stored as proof of acceptance by the signee of said service contract.

17. The system of claim 16, wherein said wireless service contract has a duration greater than one year.

18. The system of claim 16, wherein said handheld delivery information acquisition device is further configured for displaying information instructing an agent of said shipping carrier to obtain positive identification of an authorized recipient of said package before accepting an electronic signature.

19. The system of claim 16, wherein said shipping carrier server is configured for, after receiving and storing said electronic signature, transmitting said electronic signature to said wireless carrier server.

20. The system of claim 16, wherein said wireless carrier server is configured for transmitting at least a portion of said delivery information to said shipping carrier server.

21. A method of obtaining customer acceptance of a service contract for providing service to a particular item, said method comprising the steps of:
(A) transporting a package to a customer on behalf of a seller of a particular item, said package containing said particular item;
(B) obtaining positive identification of said customer;
(C) obtaining an electronic signature from said customer using a handheld delivery information acquisition device, wherein:
said handheld delivery information acquisition device comprises:
a processor;
memory linked to said processor;
a display; and
a handwriting input device;
said handheld delivery information acquisition device is configured to:
receive an electronic signature via said handwriting input device; and
after receiving said electronic signature, transmit said electronic signature to a remote server; and
said electronic signature serves at least as acceptance of said service contract associated with said particular item;
(D) relinquishing said package to said customer; and
(E) providing said seller with said electronic signature as proof of acceptance of said service contract by said customer.

22. The method of claim 21, further comprising the step of displaying said service contract to said customer via said display of said handheld delivery information acquisition device.

23. The method of claim 21, further comprising the step of presenting said service contract to said customer, wherein said package further includes at least said service contract.

24. The method of claim 21, further comprising the step of transmitting said service contract to said customer, wherein the step of transmitting said service contract to said customer is accomplished by a step selected from a group consisting of:
mailing said service contract to said customer;
emailing said service contract to said customer; and
faxing said service contract to said customer.

25. The method of claim 21, wherein said particular item is a wireless communication device and said service contract is a wireless service contract.

26. The method of claim 25, wherein said wireless communication device is a cellular telephone.

27. The method of claim 21, wherein said electronic signature further serves as acceptance of said package containing said particular item.

28. The method of claim 21, further comprising the step of obtaining a second electronic signature from said customer;
wherein:
said electronic signature is a first electronic signature; and
said second electronic signature will serve as proof of acceptance of said package.

29. A method of obtaining customer acceptance of a wireless service contract for providing service to a wireless communication device, said method comprising the steps of:
(A) receiving a shipping notification from a wireless carrier, said notification indicating that said wireless carrier wishes to ship said wireless communication device to a customer of said wireless carrier;
(B) receiving a package from said wireless carrier, said package including at least said wireless communication device;
(C) transporting said package to said customer on behalf of said wireless carrier
(D) obtaining positive identification of said customer;
(E) obtaining an electronic signature from said customer using a handheld delivery information acquisition device, wherein:
(i) said handheld delivery information acquisition device comprises:
a processor;
memory linked to said processor;
a display; and
a handwriting input device;
(ii) said handheld delivery information acquisition device is configured for:
receiving an electronic signature via said handwriting input device; and
after receiving said electronic signature, transmitting said electronic signature to a remote server; and
(iii) said electronic signature serves at least as acceptance of said wireless service contract associated with said wireless communication device;
(F) relinquishing said package to said customer; and
(G) transmitting said electronic signature to a remote server using said handheld delivery information acquisition device to store as proof of acceptance of said wireless service contract by said customer.

30. The method of claim 29, further comprising the step of displaying said wireless service contract to said customer via said display of said handheld delivery information acquisition device.

31. The method of claim 29, further comprising the step of presenting said service contract to said customer, wherein said package further includes at least said wireless service contract.

32. A computer readable medium storing computer executable instructions for:
receiving delivery information relating to the delivery of a package containing a particular item;
receiving service contract information including the terms of a service contract associated with said particular item;
displaying a service contract via the display of a handheld delivery information acquisition device;
receiving an electronic signature via the handwriting input device of a handheld delivery information acquisition device; and
transmitting said electronic signature to a remote server to store as proof of the acceptance by the signee of a service contract.
